(19) United States
(12) Patent Application Publication
(10) Pub. No.: US 2015/0313175 A1
(43) Pub. Date: Nov. 5, 2015

(54) Rabbit Hay Feeder

(71) Applicant: Annette McDaniel, Caliente, CA (US)

(72) Inventor: Annette McDaniel, Caliente, CA (US)

(21) Appl. No.: 14/269,118

(22) Filed: May 3, 2014

(51) Int. Cl. A01K 1/10; A01K 5/01

(52) U.S. Cl. CPC A01K 1/10; A01K 5/01

(57) ABSTRACT

The disclosed Invention Is a rabbit hay feeder for storing and dispensing hay to rabbis within cages and comprises a hay chamber and an upwardly open spill collector. The hay chamber comprises a front panel, a rear panel, and a pair of opposed side panels, and the spill collector comprises a bottom panel the side panels and a front lip arising from the bottom panel and disposed between the side panels. The rabbit hay feeder may have a cover, a mounting means and a closure means for the bottom of the hay chamber.

### REFERENCE TO SEQUENCE LISTING, A TABLE, OR A COMPUTER PROGRAM LISTING COMPACT DISK APPENDIX

Not Applicable

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Technical Field

The present invention is related to rabbit hay feeders and more particularly to hay feeders that regulate the amount of hay exposed, thereby limiting waste.

2. Background

Best known for being prolific, rabbits are also herbivores that efficiently convert fodder to food. The whole point of meat production is to convert plant proteins of little or no use to people as food into high-value animal protein. In efficient production systems, rabbits can turn 20 percent of the proteins they eat into edible meat. Comparable figures for other species are 22 to 23 percent for broiler chickens, 16 to 18 percent for pigs and 8 to 12 percent for beef.

A similar calculation for the energy cost of these proteins is even more unfavorable to ruminants. When cattle or sheep are raised for meat production, most of the energy consumed by the herd or flock is used to maintain breeding females which have a low prolificacy: a maximum of 0.8 to 1.4 young per year against 40 for female rabbits. Even with the theoretical lower energy cost when cattle are raised for both milk and beef, rabbit meat is still more economical in terms of feed energy than beef. Rabbit meat production is therefore an attractive proposition, especially when the aim is to produce quality animal protein.

In the wild, rabbits eat predominantly grass, and they may graze for up to 6-8 hours a day. Their whole digestive tract from their teeth right down to the end of their gastrointestinal tract is adapted to this diet and eating habit. Therefore providing grass or grass hay to rabbits is critical to maintaining health. Eating grass and grass hay provides for long periods of chewing which is necessary to wear down their continuously erupting and growing teeth, thereby helping to prevent dental disease. Rabbits are intelligent animals, and chewing on grass or grass hay helps to keep them occupied and prevent boredom.

Hay is grass, legumes or other herbaceous plants that have been cut, dried, and stored for use as animal fodder, particularly for grazing livestock such as cattle, horses, goats, and sheep. Hay is also fed to pets such as rabbits and guinea pigs. The high fiber content of grass and grass hay is also crucial for normal gastrointestinal motility. Feeding the right diet is one of the most important factors in maintaining a healthy rabbit.

Fiber is vital to the normal function of the digestive system in rabbits. Fresh grass hay and vegetables should make up the bulk of the diet for raised rabbits. Feeding a diet consisting mainly of pellets may result in obesity and increase the likelihood of digestive problems. While there is some fiber in pellets, it is finely ground and does not appear to stimulate intestinal function as well as fiber found in grass hays. Roughage also aids in the prevention of hairballs. The addition of a few pellets does add some balance to the diet; however these should not be the only food source.

Hay, in the form of grass hays such as timothy or oat hay, should be available to rabbits at all times. Long stemmed forage is thought by many experienced rabbit raisers to be the most important feed to maintain good gut motility in rabbits. Some rabbits, such as a bunny or a young rabbit (kit) weaning from their mother's milk, or a rabbit previously fed a diet of pellets only, may not take much hay at first. When kits are being weaned, they are prone to enteritis, which results in diarrhea and often death. Providing a constant source of hay greatly reduces or eliminates the incidence, leading to greater profits for the raiser due to lessened mortality rates. People who breed show rabbits or for meat often have hundreds or thousands of cages of individual rabbits, and may forego feeding hay because it usually entails having to open each cage, and the hay lost through the cage floor would significantly raise the cost of providing forage.

It is therefore a principal object of the invention to provide an improved rabbit hay feeder.

A further object of the invention is to provide a rabbit hay feeder that catches excess hay onto a spill collector.

A further object of the invention is to provide a feeder of the type described which does not allow an excess of the hay being dispensed into the area where the animal is being fed.

A further object of the invention is to provide a feeder that reduces feed waste.

A further object of the invention is to provide a feeder that reduces, if not eliminates, the waste of feed caused by too much feed being accessed at a time.

A further object of the invention is to provide an animal feeder of the type described which is economical of manufacture, durable in use and refined in appearance.

Another further object is to allow for filling the feeder without opening the cage door.

These and other objects will be apparent to those skilled in the art.

### BRIEF DESCRIPTION OF THE DRAWINGS

A preferred form of the present invention is shown in the accompanying drawings in which:

FIG. 1 is a front elevation view of a rabbit hay feeder;

FIG. 2 is a cross-sectional view taken along line 2-2 in FIG. 1;

FIG. 3 is a cross-sectional view taken along line 3-3 in FIG. 1;

FIG. 4 is a back elevation view of a rabbit hay feeder.

### DETAILED DESCRIPTION OF A PREFERRED EMBODIMENT

The above description and attached drawings are given by way of example to set forth a preferred form of the present invention. Modifications and alterations of the described and illustrated elements may be envisioned which fall within the scope of the following claims.

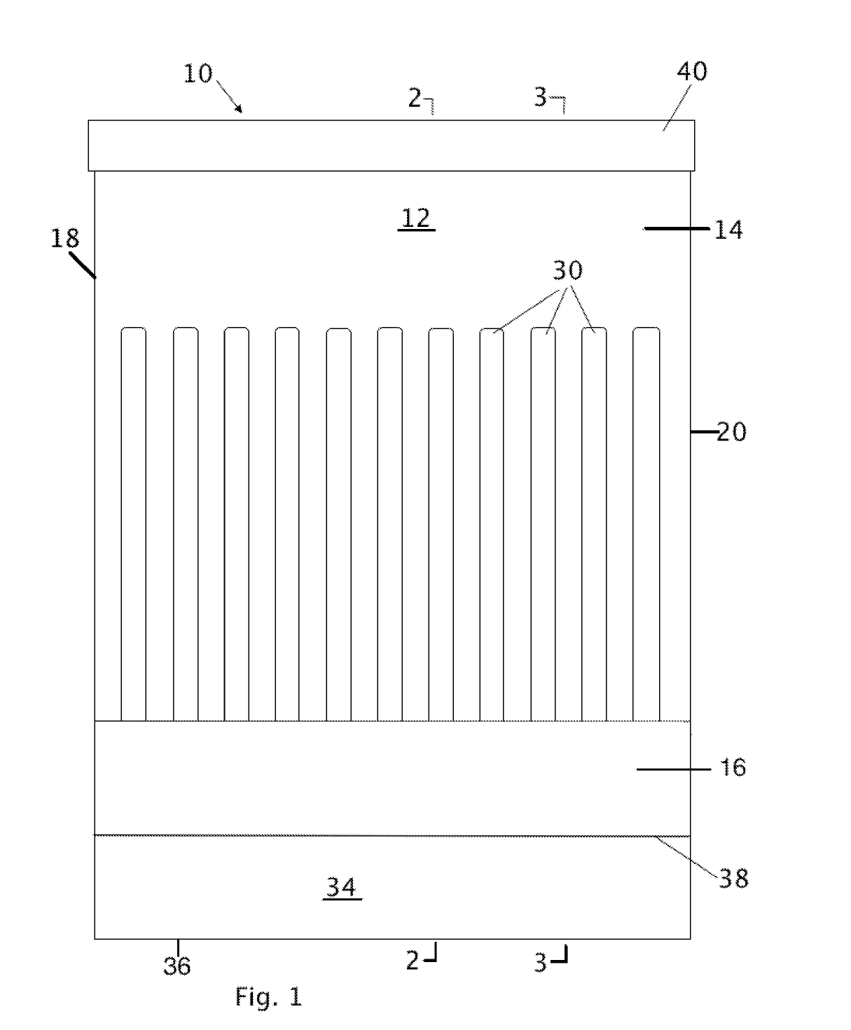

A rabbit hay feeder 10 according to the present invention is shown in FIGS. 1, 2 and 3. As shown in FIG. 1, the rabbit hay feeder 10 comprises a hay chamber 12 and an upwardly open spill collector 34. The hay chamber 12 comprises a front panel 14, a rear panel 16, and a pair of opposed side panels 18, 20, and the spill collector 34 comprises a bottom panel 36, the side panels 18, 20 and a front lip 38 arising from the bottom panel 36 and is disposed between the side panels 18, 20. The front panel 14 has a plurality of vertical openings 30 provided through the material of the front panel 14, and each of the openings 30 extends upward from approximately the front panel 14 bottom to a predetermined height of the front panel 14. The height of the openings 30 in the front panel 14 is between approximately one-half the height of the front panel 14 and approximately two-thirds the height of the front panel 14. The cover 40 is also shown.

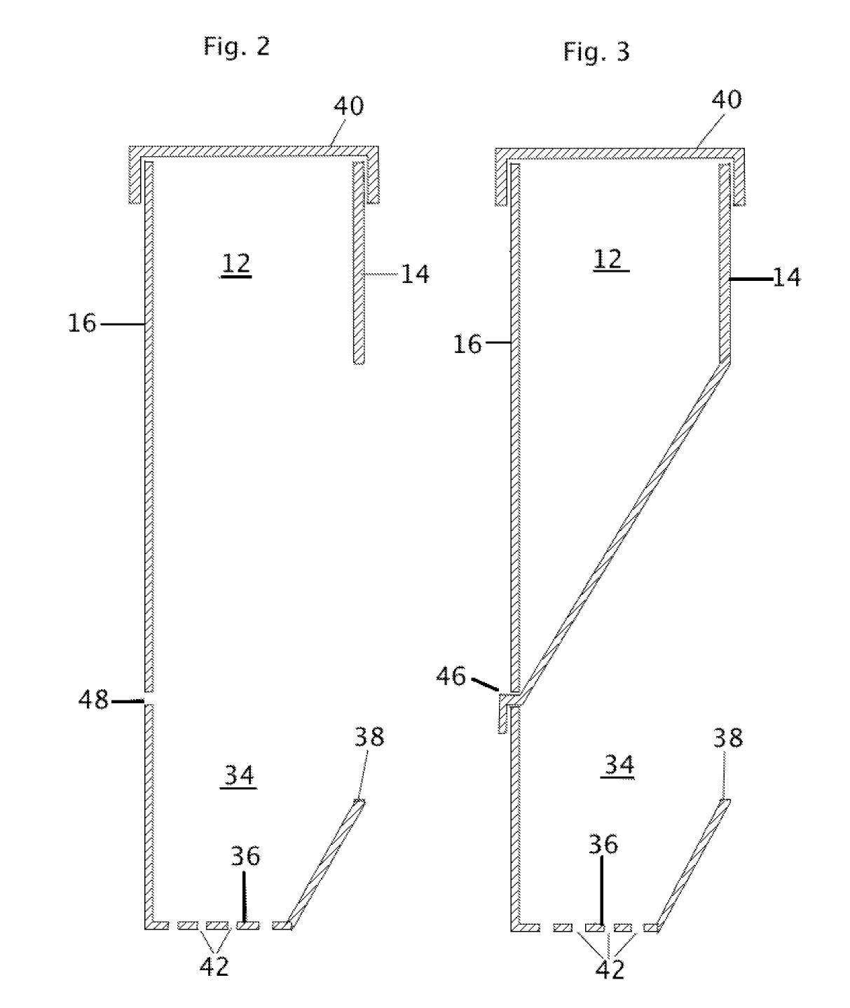

FIGS. 2 and 3 are cross-sections of FIG. 1 taken through an opening 30 in the front panel 14 in the case of FIG. 2 and through the solid portion of the front panel 14 in the case of FIG. 3. The hay chamber closure means 46, shown in FIG 3, is shown as a slot 48 through the rear panel 16, which is best seen in FIG. 2. The closed hay chamber 12 is shown in FIG. 3, and serves to retain a portion of a flake or flakes of hay. The upwardly open spill collector 34 is seen beneath the hay chamber 12 and serves to capture and retain any hay pulled from the hay chamber 12 that is dropped and not immediately eaten. The plurality of apertures 42 traversing the bottom panel 36 allows any spilled or transferred moisture to drain and for passive air flow that aids in keeping the hay that falls into the upwardly open spill collector 34 dry and fresh. The front lip 38 is also shown.

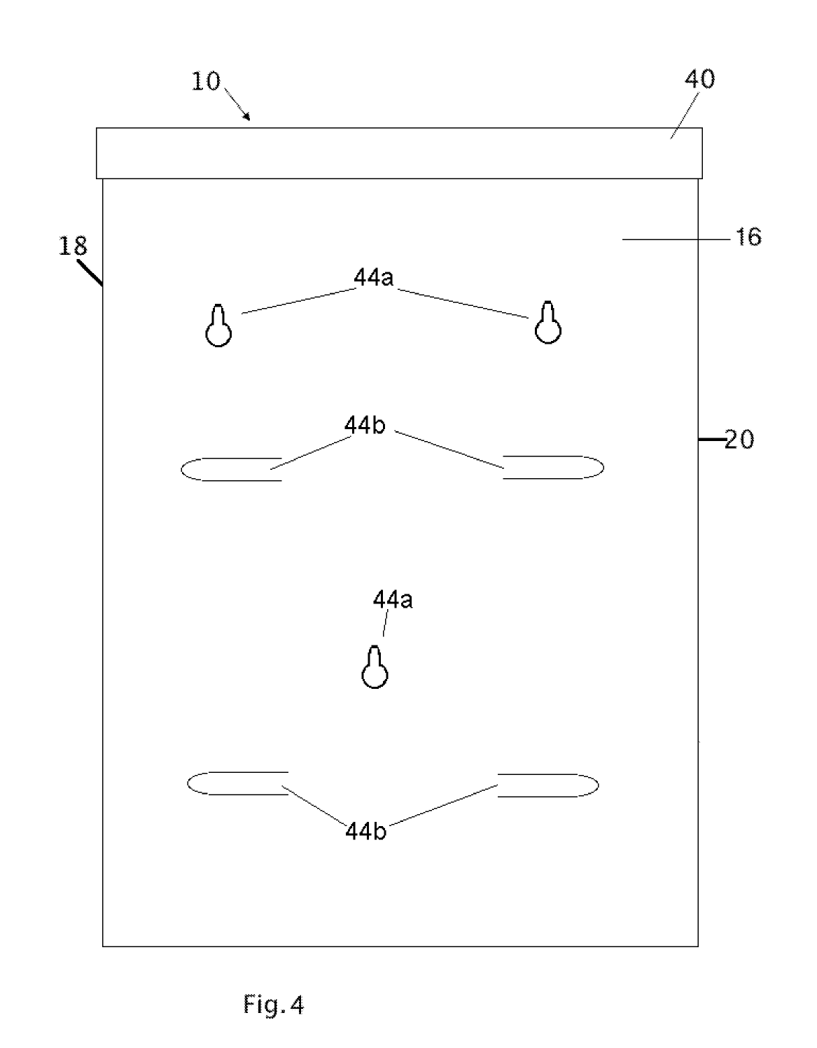

FIG. 4 shows the back of the rabbit hay feeder and displays a variety of the mounting means 44 that may be used to attach the rabbit hay feeder to rabbit cages. The mounting means 44a are openings traversing the panel that would be used with screws, nails or other protruding attachment means, while the mounting means 44b are tabs, flaps or “ears” on the rabbit hay feeder that while unengaged would be in the same plane as the panel the openings traverse and when engaged may be moved away from the plane of the rabbit hay feeder panel and attached to wires of the rabbit cage or hutch, or any other suitable mount. While the mounting means 44a and 44b are shown on the back of the rabbit hay feeder, they may as easily be placed upon the front of the rabbit hay feeder.

The disclosed invention is a rabbit hay feeder for storing and dispensing hay, and comprises a hay chamber and an upwardly open spill collector. The hay chamber comprises a front panel, a rear panel, and a pair of opposed side panels, and the spill collector comprises a bottom panel, the side panels and a front lip arising from the bottom panel and disposed between the side panels.

The hay chamber front panel has a height less than the height of the rear panel and the height of the side panels. The front panel has a plurality of vertical openings provided through the material of the front panel, and each of the openings extends from approximately the front panel bottom to a predetermined height of the front panel. The height of the openings in the front panel is between approximately one-half the height of the front panel and approximately two-thirds the height of the front panel. The height of the openings are chosen dependent upon the breed of rabbit that will be fed, as larger breeds will require the exposure of a larger amount of hay.

The openings may begin at the bottom of the front panel rather like fingers, or there may be a band of material at the bottom and the openings commence above this band of material. The openings are equally sized, and are approximately the same width as the width of the remaining material. The openings allow for access to the feed placed within the hay chamber and allow the rabbit to withdraw hay as desired. The width of the openings are sized to mostly retain the hay within the chamber so that it cannot fall out or be pulled out in large clumps yet large enough to still allow for access to the hay. Hay in bales tends to break into pieces, called flakes, in the range of four to six inches wide, and the hay chamber is sized to retain a partial portion or segment of a flake or flakes of hay, generally one in the case of a smaller feeder and two in a larger feeder.

There is an upwardly open spill collector communicating with the hay chamber to receive hay spilled therefrom, and the spill collector comprises a bottom panel, the side panels and a front lip arising from the bottom panel and disposed between the side panels. The bottom panel may further comprise a plurality of apertures traversing the bottom panel. These apertures allow for the sifting of fines, or very small particles in a mixture of various sizes, from the hay such that if the feeder is mounted on the outside of the hutch, these fines would fall outside the hutch. The apertures additionally provide for airflow through the hay left inside the spill collector resulting in dryer hay with less waste from molding or becoming otherwise inedible. The bottom panel serves to catch both the stems and especially the leaves from the hay, which are valuable as they are highest in protein. The apertures allow for good airflow to prevent mold development and also allow for drainage should a rabbit kit urinate in the basin.

The invention may further comprise a cover releasably engaged to the hay chamber, so that the cover engages the top of the hay chamber to protect the enclosed feed from the elements. The cover may be a friction fit type of cover or it may be held by an attachment on the chamber, as by a hinge or by retention wires. There may be a mounting means for mounting the rabbit hay feeder, and the mounting means may be a plurality of holes placed through the rear panel for attaching the feeder to a flat support, a plurality of wires attached to the feeder that may be used to attach the feeder to a rabbit hutch, or a plurality of cut-outs or punch-outs in the body of the feeder that can be pushed outward to create tabs that would then engage the wires of a rabbit hutch. The rabbit hay feeder can be placed outside of a rabbit hutch and the wires that form the hutch would be cut to allow the animal access to the hay. The rabbit hay feeder may also be placed inside the hutch so that the hutch walls do not have to have wires cut.

There may be a closure means at the bottom of the hay chamber to assist in retaining the hay within the hay chamber. The closure may be effected by a slot in the rear panel that the front panel bottom passes through and then bending the front panel bottom to lie against the rear panel to seal the hay chamber or by adhering the front panel to the rear panel as by welding, in the case of a metal feeder, or by use of an adhesive or solvent welding in the case of a plastic feeder. Additionally, the closure may also be formed when the rabbit hay feeder is made, as in the case of plastic extrusion, blow molding, injection molding or 3-d printing.

The height of the rabbit hay feeder may be in the range of three to five times the depth, depending on the breed of rabbit to be fed, as larger breeds will be better fed by a larger feeder and the smaller breeds might waste more food given the larger expanse of open area from which to pull the enclosed hay.

The disclosed invention allows free access to hay by the animal, concurrently minimizing waste and preventing contamination occurring by offering hay on the cage floor or by other means. This design has several unique features. It can be mounted either on the interior or exterior of the cage, and can be configured to allow for filling the hay chamber without having to open the cage door. When mounted on the interior, several of the top wires of the cage would necessarily be cut to fit the hopper opening to allow for filling with hay, and when mounted on the exterior, wire would necessarily be cut to allow access to the slotted face and catch basin of the unit.

Rabbit raisers that are averse to cutting cage wire have the option of mounting the unit on an interior wall of the cage at an elevation sufficient to allow for filling the hay chamber without breaching the integrity of the cage itself.

The dimensions of the device could be chosen to correspond to the industry standard of cage wire, for example, 1″×2″, 1″×1″, or ½″×1″ so that the unit fills the void where the wire of the cage is cut.

The vertical section of the hay chamber supports the portion of the hay flake and maintains its integrity while the openings allow for access to the hay by the animal.

One disclosed embodiment of the invention uses a plurality of apertures in the spill collector that serves to catch both the stems and especially the leaves from the hay, as they are highest in protein. The apertures allow for good airflow to prevent mold development and also allow for drainage should a rabbit kit urinate in the basin.

What is claimed is:

1. A rabbit hay feeder for storing and dispensing hay comprising:
a hay chamber comprising a front panel, a rear panel and a pair of opposed side panels, the front panel having a height less than the height of the rear panel and the side panels, the front panel having a plurality of vertical openings provided therethrough each of the front panel openings extending from approximately the front panel bottom to a predetermined height of the front panel, the plurality of openings allowing for access to feed;
an upward open spill collector communicating with the hay chamber to receive hay spilled therefrom, the collector comprising a bottom panel, the side panels and a front lip arising from the bottom panel and disposed between the side panels.

2. The rabbit hay feeder of claim 1 further comprising a cover releasably engaged to the hay chamber.

3. The rabbit bay feeder of claim 1 further comprising a plurality of apertures traversing the spill collector bottom panel.

4. The rabbit hay feeder of claim 1 further comprising mounting means for mounting the feeder.

5. The rabbit hay feeder of claim 1 wherein the hay chamber is sized to retain a predetermined number of flakes of hay.

6. The rabbit hay feeder of claim 1 further comprising a closure means at the bottom of the hay chamber.

7. The rabbit hay feeder of claim 1 wherein the height of the front panel openings are approximately one-half the height of the front panel.

8. The rabbit hay feeder of claim 1 wherein the height of the front panel openings are approximately two-thirds the height of the front panel.

9. A rabbit hay feeder for storing and dispensing hay comprising:
a hay chamber comprising a front panel a rear panel, and a pair of opposed: side panels, the front panel having a height less than the height of the rear panel and the side panels, the front panel having a plurality of vertical openings provided therethrough, each of the front panel openings extending from approximately the front panel bottom to a predetermined height of the front panel, the plurality of openings allowing for access to feed;
an upwardly open spill collector communicating with the hay chamber to receive hay spilled therefrom, the collector comprising a bottom panel, the bottom panel further comprising a plurality of apertures traversing the bottom panel the side panels and a front lip arising from the bottom panel and disposed between the side panels.

10. The rabbit hay feeder of claim 9 further comprising a cover releasably engaged to the hay chamber.

11. The rabbit hay feeder of claim 9 further comprising a mounting means for mounting the feeder.

12. The rabbit hay feeder of claim 9 wherein the hay chamber is sized to retain a predetermined number of flakes of hay.

13. The rabbit bay feeder of claim 9 further comprising a closure means at the bottom of the hay chamber. 14. The rabbit hay feeder of claim 8 wherein the height of the front panel openings are approximately one-half the height of the front panel
15. The rabbit hay feeder of claim 9 wherein the height of the front panel openings are approximately two-thirds the height of the front panel
16. A rabbit hay feeder for storing and dispensing hay comprising;
a hay chamber sized to rotate a predetermined number of flakes of hay comprising a front panel, a rear panel and a pair of opposed side panels, the front panel having a height less than the height of the rear panel and the side panels the front panel having; a plurality of vertical openings provided therethrough, each of the front panel openings extending from approximately the front panel bottom to a predetermined height of the front panel the plurality of openings allowing for access to feed;
a mounting means for mounting the feeder;
a closure means at the bottom of the hay chamber:
an upwardly open spill collector communicating with the hay chamber to receive hay spilled therefrom the collector comprising a bottom panel, the bottom panel further composing a plurality of apertures traversing the bottom panel the side panels and a front lip arising from the bottom panel and disposed between the side panels.
17. The rabbit hay feeder of claim 16 further comprising a cover releasably engaged to the hay chamber
18. The rabbit: hay feeder of claim 16 wherein the height of the front panel openings are approximately one-half the height of the front panel 19. The rabbit hay feeder of claim 16 wherein the height of the front panel openings are approximately two-thirds the height of the front panel
20. The rabbit hay feeder of claim 16 wherein the height of the rabbit hay feeder is in the range of three to five times the depth of the feeder.
